(19) United States
(12) Patent Application Publication
(10) Pub. No.: US 2010/0288748 A1
(43) Pub. Date: Nov. 18, 2010

(54) WARMING CART

(76) Inventors: Robert C. Fortmann, Grayslake, IL (US); Frank G. Marolda, Vernon Hills, IL (US)

Correspondence Address: BRINKS HOFER GILSON & LIONE, P.O. BOX 10395, CHICAGO, IL, 60610, US

(21) Appl. No.: 12/778,705

(22) Filed: May 12, 2010

Related U.S. Application Data
(60) Provisional application No. 61/178,546, filed on May 15, 2009.

(51) Int. Cl. H05B 1/00

(52) U.S. Cl. 219/385

(57) ABSTRACT

A cabinet is provided. The cabinet is configured to receive and support a plurality of trays therein. The cabinet includes a housing defining an enclosure with a top, a bottom, and right and left sides disposed between the top and bottom and a plurality of shelves disposed within the enclosure and disposed between the right and left sides in a spaced relationship. One or more heaters are disposed in conjunction with each of the plurality of shelves. A cover is disposed directly below at least some of the plurality of shelves, and configured to be slidably connected with respect to the shelf for selective placement into the enclosure or removal from the shelf. A control system is in electrical communication with the one or more heaters, and is configured to operate the one or more heaters in a predetermined manner.

### CROSS-REFERENCE TO RELATED APPLICATIONS

This application claims priority under 35 U.S.C. §119(e) to U.S. Provisional Application No. 61/178,546, filed on May 15, 2009, and entitled “Warming Cart,” the entirety of which is hereby fully incorporated by reference herein.

### TECHNICAL FIELD

The subject disclosure relates to carts and cabinets that are configured to maintain a previously cooked food product warm during a delay time between the cooking process and serving to the customer.

### BRIEF SUMMARY

A first representative embodiment of the disclosure provides a warming cart. The cart includes a housing defining an enclosure with top, bottom, right, and left walls and a plurality of racks disposed within the housing in a vertically spaced arrangement. A plurality of heaters are disposed in conjunction with the plurality of racks, with at least one of the plurality of heaters being disposed in conjunction with each of the plurality of racks. The plurality of heaters are configured to operate on a duty cycle to maintain the racks within a specified desired temperature range.

A second representative embodiment of the disclosure provides a cabinet configured to receive and support a plurality of trays therein. The cabinet includes a housing defining an enclosure with a top, a bottom, and right and left sides disposed between the top and bottom. A plurality of shelves are disposed within the enclosure and disposed between the right and left sides in a spaced relationship. One or more heaters are disposed in conjunction with each of the plurality of shelves. A cover is disposed directly below at least some of the plurality of shelves, and configured to be slidably connected with respect to the respective shelf for selective placement into the enclosure or removal from the shelf. A control system is in electrical communication with the one or more heaters and is configured to operate the one or more heaters in a predetermined manner.

A third representative embodiment of the disclosure provides a cabinet configured to receive and support a plurality of trays therein. The cabinet includes a housing defining an enclosure with a top, a bottom, and right and left sides disposed between the top and bottom, the housing comprising substantially open front and back sides. A plurality of shelves are disposed within the enclosure and disposed between the right and left sides in a spaced relationship. One or more heaters are disposed in conjunction with each of the plurality of shelves. A cover is disposed directly below at least some of the plurality of shelves, and configured to be slidably connected with respect to the respective shelf for selective placement into the enclosure or removal from the shelf. A control system is in electrical communication with the one or more heaters and is configured to operate the one or more heaters in a predetermined manner.

Advantages of the disclosed cabinet of use will become more apparent to those skilled in the art from the following description of embodiments that have been shown and described by way of illustration. As will be realized, other and different embodiments are contemplated, and the disclosed details are capable of modification in various respects. Accordingly, the drawings and description are to be regarded as illustrative in nature and not as restrictive.

### BRIEF DESCRIPTION OF THE DRAWINGS

FIG. 1 is a perspective view of a warming cabinet showing a pan disposed therein.

FIG. 2 is a front view of the warming cabinet of FIG. 1.

FIG. 3 is a detail view of detail A of FIG. 2.

FIG. 4 is the view of FIG. 1 showing a cover partially removed from the warming cabinet.

FIG. 5 is the view of FIG. 1 showing the operable portions of the control system of the warming cabinet.

FIG. 6 is a back view of another warming cabinet.

FIG. 7 is a schematic of the control circuit used with a warming cabinet.

### DETAILED DESCRIPTION

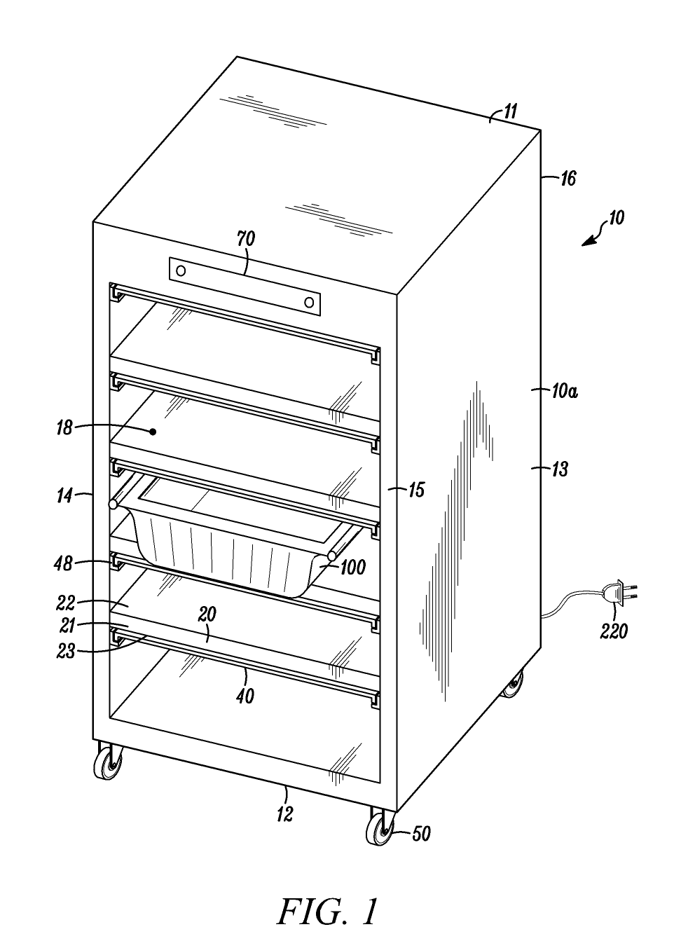

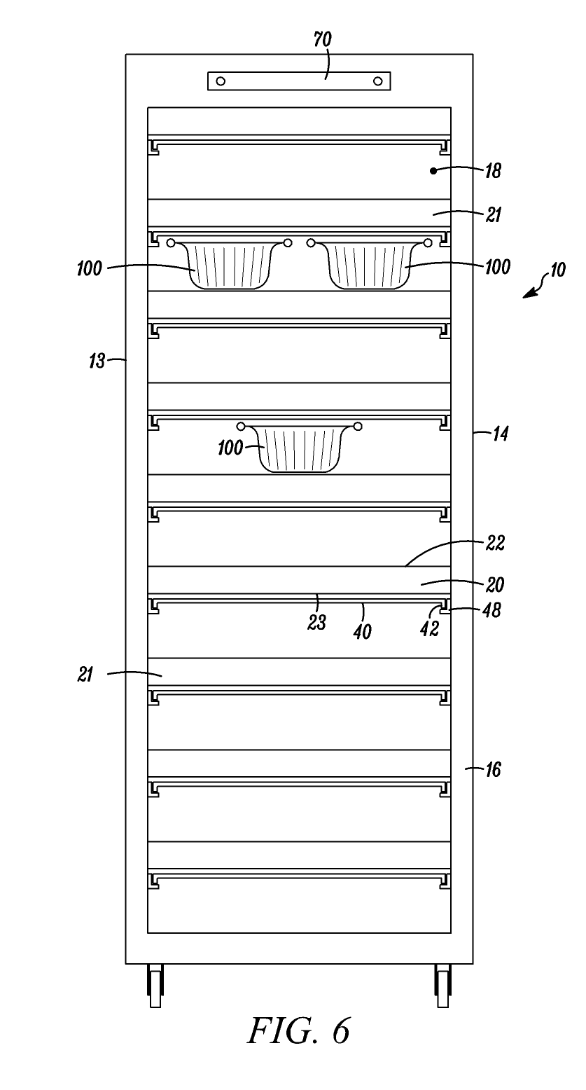

Turning now to FIGS. 1-7, a warming cart or cabinet 10 is provided. The warming cart 10 includes a body 10a that is defined from a top wall 11, a bottom wall 12, a left wall 14, and a right wall 13 that define a warming volume 18 therein. The warming cart 10 is configured with an open front side 15 and an open back side 16 to allow one or more pans 100 to be quickly disposed within the cart 10 and the warming volume and removed from the cart 10 without operation of doors or other barriers found on conventional warming carts. As shown in FIGS. 1, 2, 4, and 5 the front side 15 is open to allow pans 100, trays, pizza boxes and the like to slide through the open front side 15 and within the warming volume 18 of the cart, and as shown in FIG. 6 the back side 16 is also open to allow pans 100 and the like to slide through the back side 16 into the warming volume 18. The cart 10 may be a free standing unit and may be provided with castors, wheels, or the like 50 upon the bottom thereof to allow the cart 10 to be easily transported. In some embodiments, the cart 10 may be 5-6 feet tall and configured to movably rest upon the floor of the establishment, while in other embodiments, the cart 10 may be only about 1-2 feet tall and configured to rest upon a table or other elevated surface within the establishment.

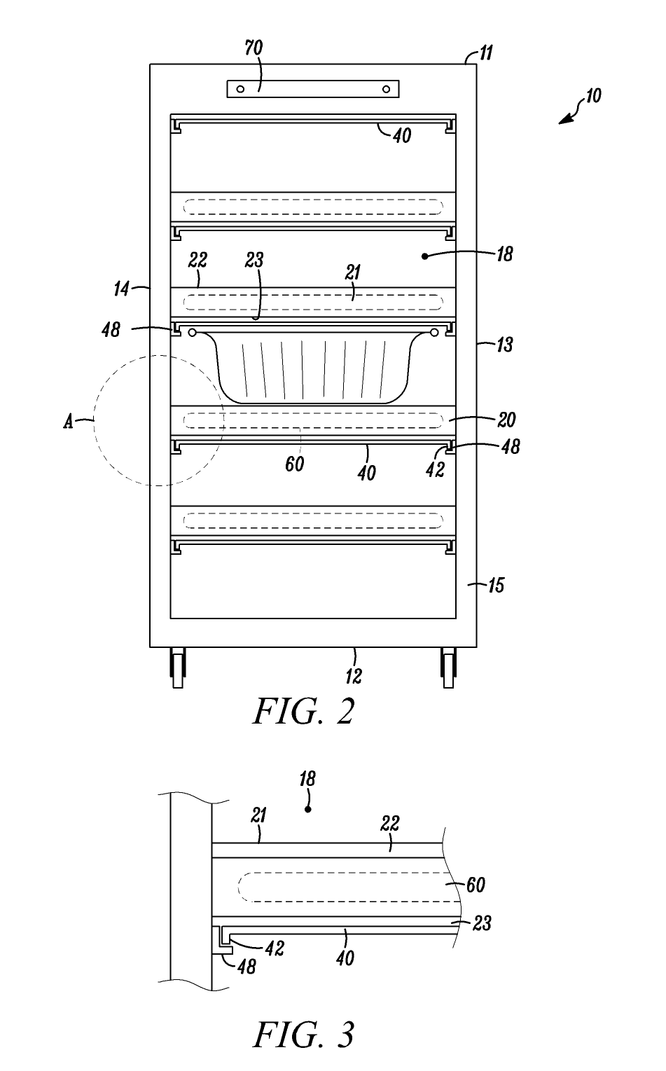

The warming cart 10 includes a plurality of racks 20 that are disposed in a vertical orientation with respect to each other and disposed between the right and left walls 14, 13 within the warming volume 18. The racks 20 each include a shelf 21 that is fixed to the right and left sides 14, 13 of the body 10a, with the top surface 22 of the shelf 21 being spaced from a bottom surface 23 of a neighboring shelf 21a distance to allow a conventional restaurant cooking pan 100 to be inserted therebetween (FIG. 2). In some embodiments, the shelves 21 are disposed within the cart 10 with a vertical spacing just greater than the normal 2.5 inch depth of conventional restaurant warming pans 100. In some embodiments, the shelves 21 are configured with sufficient width to accept two or more standard 12 inch wide restaurant warming pans therewithin in a side by side relationship (FIG. 6), with a length of just greater than 20 inches to allow the pans to be completely received within the warming volume 18 of the cart 10 (FIG. 1). In other embodiments, the cart 10 may be sized to receive a single restaurant pan on each shelf, or to receive a conventionally sized pizza box (such as an 18 inch square box) upon each shelf 21.

In some embodiments, the cart 10 may include 2, 5 (FIG. 1), 10 (FIG. 6), or another number of vertically spaced shelves 21 within the warming volume 18. The shelves 21 may include one or more heaters 60 (as discussed in greater detail below) therein or therewith, such that the shelves 21 may each produce about 300 watts of heat during steady state operation. For example, in embodiments with 5 or fewer shelves, the unit may be operable with 120v 15 amp service, while in larger units with greater than 5 shelves, or greater than 300 watts per shelf, the unit may require higher 208 v service.

The plurality of shelves 21 may each include a removable and slidable cover 40 that is disposed in conjunction with and below each shelf 21 (with the exception of the bottom shelf 21, with a cover 40 also provided above the upper-most shelf). The cover 40 is configured to provide a lid to each restaurant or hotel pan 100 that is placed onto the shelf 21 within the warming volume 18 such that the heat from the food products disposed within the pan 100 (and the heat of the residual heat of the pan 100 itself) is substantially prevented from escaping due to convective heat transfer. The cover 40 additionally substantially encloses the one or more pans 100 disposed upon the shelf 21 therebelow, which maintains any moisture or water vapor within the pan 100 to prevent the warmed food disposed within the pan 100 from drying if the food is maintained in the unit for an extended period of time. An additional cover 40 may be slidably disposed at the top of the warming volume 18 to enclose a pan 100 that is disposed upon the upper-most shelf 21.

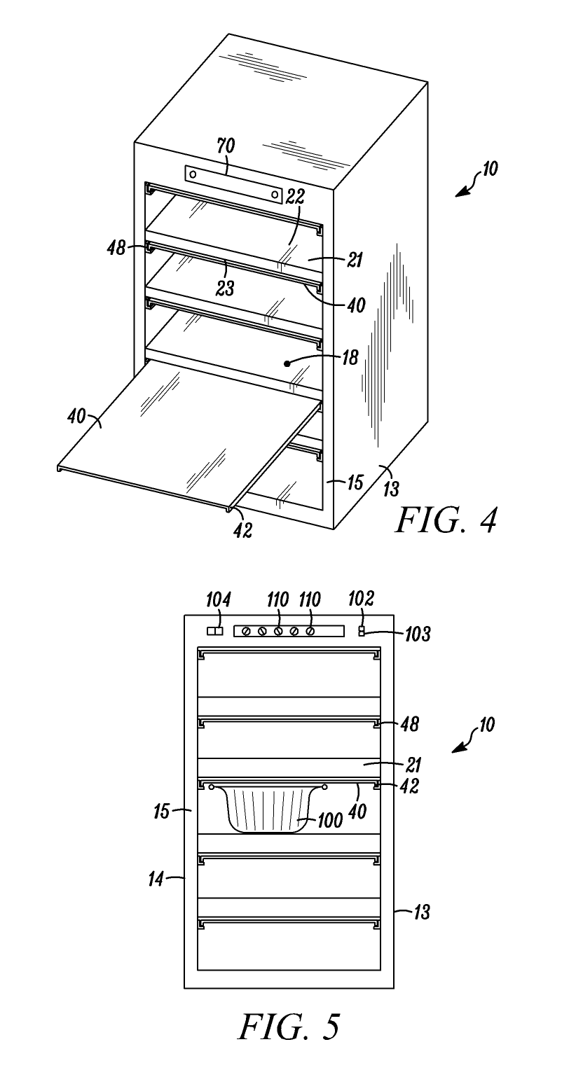

The covers 40 are disposed onto the respective shelves 21 to be removable as necessary, by sliding the cover 40 from the shelf 21 by way of a track 48 that is either disposed upon the right and left side walls 13, 14 (FIG. 2) of the body housing 10a (and located proximate and below the location where each shelf 21 connects with the right and left side walls 13, 14) or a track 48 may be fixed directly to the respective shelf 21 and is disposed beneath each of the right and left sides of the shelf 21. In some embodiments, as shown in FIGS. 3-4, the cover 40 may include flanges 42 or similar structures that are closely received within the track 48 to encourage stability within the track 48 and ease of sliding movement therewithin. The covers 40 are disposed to provide a spacing between the cover 40 and the shelf 21 disposed thereunder that receives a conventional restaurant cooking pan 100 therebetween, with little to no space between the upper edges of the pan 100 and the bottom surface of the cover 40. In some embodiments, this spacing may be just greater than 2.5 inches, the depth of conventional restaurant warming pans. This arrangement allows the pans 100 to be removed, if desired, with the cover 40 installed within the cart 10 and disposed directly above a pan 100, if desired. The cover 40 is drawn schematically in FIGS. 2 and 5 depicting a space between the top of the cover 40 and the bottom surface 23 of the shelf 21. In some embodiments, this space depicted in the drawings is provided between the cover 40 and the shelf 21, while in other embodiments the top surface of the cover 40 contacts the bottom surface 23 of the shelf 21 to provide conductive heat transfer therebetween.

Each of the plurality of shelves 21 include one or more heaters 60 (shown schematically in FIGS. 2 and 3) that are disposed within the internal volume shelf 21, or disposed under the shelf but in contact with the shelf 21. In some embodiments, the shelves 21 may include two planar sheets of thin material (such as stainless steel) that form an envelope for the heater 60 to be disposed therebetween. The heater 60 is normally disposed such that the heater 60 makes surface contact with at least the upper sheet 22 forming the shelf 21 (and also the heater 60 may contact the lower sheet 23 forming the shelf 21) such that a percentage of the heat generated by the heaters disposed in conjunction with each shelf 21 is transferred directly to the shelf by conductive heat transfer. The remaining portion of heat generated by the heaters 60 disposed in conjunction with each shelf 21 may be transferred to the shelf 21 by radiation heat transfer. It is also contemplated that some heat may be transferred to the shelf 21 via convection due to potential air currents established within the shelf 21 due to the relative different temperatures of the air at various positions within the shelf 21 and/or forced air convection in embodiments with forced air flow within the shelf 21.

In some embodiments, the shelf 21 may include a bottom sheet 23 that is disposed below the heater 60 in each shelf 21. This bottom sheet 23 may be in contact with the heater 60 to allow for conductive heat transfer thereto as well as receiving heat from the heater due to radiation heat transfer, and potentially convective heat transfer if the shelf 21 is configured to allow significant air flow (either due to natural convection and/or forced air convection) within the shelf 21. The shelf 21, and specifically the bottom sheet 23 of the shelf 21, and the cover 40 are configured to transfer a portion of the heat generated by the one or more heaters 60 disposed within the shelf 21 to the portion of the warming volume 18 located below the shelf 21. Accordingly, a pan 100 disposed within the cart 10 may receive heat from both the shelf 21 below the pan (by conduction and radiation), but the pan 100 and the food product located within the pan 100 may receive heat from the shelf 21 disposed above the pan 100 due to radiation.

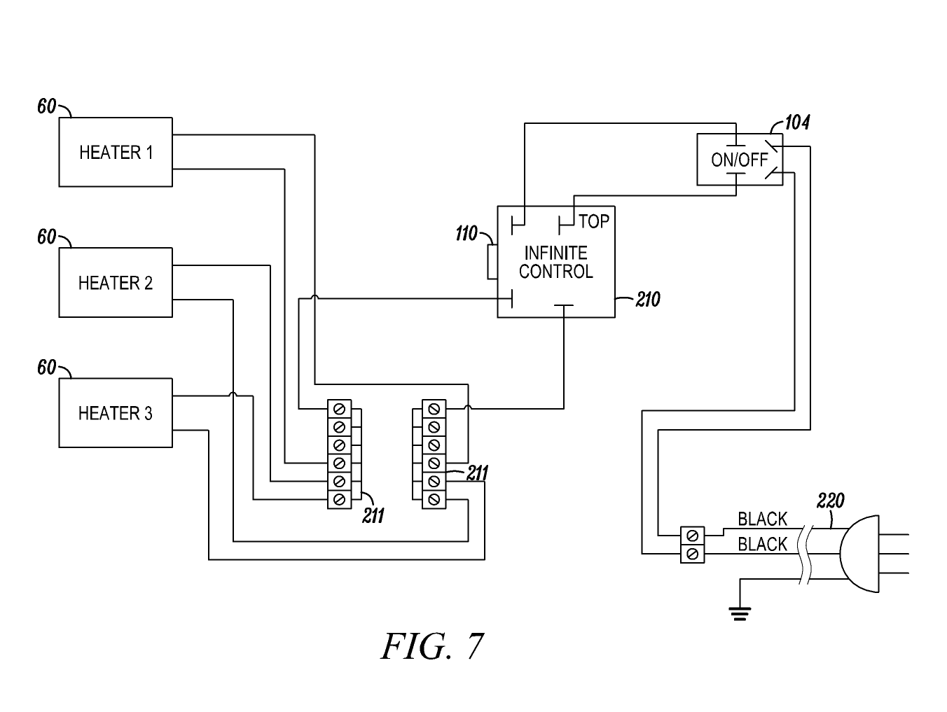

As shown in FIG. 7, each of the one or more heaters 60 is operated by control circuitry 200 located within the cart 10 that is configured to control the duty cycle and the heat generation capacity of the heaters 60 and therefore the temperature of the shelves 21 and ultimately the food product disposed within the warming volume 18. In some embodiments, each shelf 21 may include one or more heaters 60 that are controlled separately from the heaters 60 that are disposed in conjunction with the remaining shelves 21. In embodiments where the heaters 60 of different shelves 21 are controlled independently, the cart 10 would include the number of control systems 200 as different heaters to be independently controlled. In embodiments with multiple control systems 200, each control system (such as the infinite switch 210) is wired in parallel (or potentially in series) with each control system 200 being energized or secured by a single On/Off switch 104. In other embodiments, multiple On/Off switches 104 may be provided on the cart 10 to allow the user to selectively provide or secure power to different shelves 21 within the cart 10.

In other embodiments, two or more shelves 21 (normally contiguous shelves 21) may controlled simultaneously to form a multiple shelf heating zone that is controlled by the same control system. As shown in FIG. 7, the control system 200 selectively provides current to multiple heaters 60, which may provide for multiple heated shelves 21 in the same zone. In still other embodiments, all of the shelves 21 may be controlled using the same control system 200.

The control system 200 may use a feedback control technology or it may use a non-feedback structure. In some embodiments, the heaters 60 (either individually or together to form zones of multiple shelves) may be controlled by one or more infinite switches 210 with the multiple heaters 60 being connected in parallel through breadboard type connectors 211. In other embodiments, the multiple heaters 60 may be connected in series in a circuit with the infinite switch 210. Infinite switches 210 include a bimetallic strip that selectively opens and closes based on the heat generated therein due to the current passing through one or more of the metals forming the strip. The infinite switch 210 is controllable by varying the orientation of the bistable, which changes the percentage of time that current is available to the heaters, and thus changes the time average output of the heaters 60.

The one or more infinite switches 210 are normally preset by the manufacturer to a setting that provides a desired steady state temperature ultimately to a food product disposed therein, wither within a pan, upon a baking sheet or the like, or within a pizza box. In embodiments with multiple heat zones, the two or more infinite switches 210 may be calibrated to establish two or more heat zones of differing temperatures within the warming volume, to allow food products that require different warming temperatures to be simultaneously disposed within the cart 10. Alternatively, the multiple heat zones within the cart 10 may be used to allow for the gradual heat up or cool down of a food product located within a pan 100 selectively disposed within each heat zone for a specified period of time. In still other embodiments, the heaters 60 (or heat zones) are specifically calibrated to generate a uniform temperature within the entire warming volume 18 of the cart 10. It has been experimentally determined that heaters disposed within or in conjunction with lower shelves 21 need to be energized a longer percentage of available time than heaters 60 disposed in conjunction with upper shelves 21, due at least in part due to the natural tendency of heat to rise. Accordingly, the manufacturer (or end user) may calibrate the infinite switches 210 for lower shelves 21 (or lower heat zones) to operate more frequently than the heaters 60 in the upper shelves 21 (or heat zones) to achieve a substantially uniform temperature within the warming volume 18 at steady state. An understanding of the heat input rate to a tray 100 disposed within a respective zone and the typical ambient heat losses from a tray 100 disposed within a zone will allow for the intelligent and controlled manipulation of pans 100 as desirable.

In some embodiments, the one or a plurality of infinite switches 210 may be disposed within the cart 10 in a sealed location 70 to prevent the users of the cart 10 from inadvertently altering the settings of the infinite switches 210 and therefore the heat input in each zone. The infinite switches 210 are preferably disposed with a closed volume of the cart that is accessible if desired by removing a limited number of conventional fasteners, to allow for relatively easy and convenient access if desired by a user or a technician.

In other embodiments, the cart 10 may include one or more infinite switches 210 that are configured to control temperature in the desired number of heating zones within the cart 10. The one or more infinite switches 210 are disposed (or may be controlled) by the end user of the cart 10 through knobs 110 or other operators that are disposed upon the cart 10 and accessible by the user. The knobs 110 may be calibrated to depict the expected temperature within the heating zone at steady state when a tray is disposed within the cart 10. The cart 10 may additionally include a power available light 102, a power on light 103, as well as an indication of the temperature within a one or a plurality of positions within the cart, or within each heating zone, or upon each shelf.

Alternatively, the cart 10 may include a feedback control system that includes one more sensors disposed in each heating zone, or within the cart 10 itself, an input device for the user to select the desired temperature at steady state within the heating zone, and a control system configured to adjust the heat output within each zone to achieve the desired temperature. In some embodiments, the controller may selectively provide or secure current to the one or more heaters 60 disposed within each zone to control the temperature of the zone. In some embodiments, the control system may include or operate in conjunction with a display that provides an indication of a temperature upon or proximate to each of the plurality of shelves 21 (or representative shelves within a specific heat zone). The control system 200 may include or communicate with an input device for the user to select a desired temperature within the specific shelf 21 or heat zone, or the user may additionally select a desired heat up rate upon a shelf or a heat zone. In some embodiments, the sensor and input device may be wired in series with the infinite switches 210 such that the sensor and input device control the percentage of time that the infinite switches operate, which provides the user with a simple and relatively inexpensive way to control the operation and temperature of the cart, and allow the user to operate the cart to achieve a consistent temperature when the ambient temperature where the cart is located may vary dramatically.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

What is claimed is:

1. A cabinet configured to receive and support a plurality of trays comprising:
a housing defining an enclosure with top, bottom, right, and left walls;
a plurality of racks disposed within the housing in a vertically spaced arrangement; and
a plurality of heaters disposed in conjunction with the plurality of racks, with at least one of the plurality of heaters being disposed in conjunction with each of the plurality of racks;
the plurality of heaters being configured to operate on a duty cycle to maintain the racks within a specified desired temperature range.

2. The cabinet of claim 1, further comprising a plurality of planar elongate sheets slidably mounted within the housing, wherein each of the plurality of sheets are received proximate one of the plurality of racks.

3. The cabinet of claim 2, wherein each of the sheets in combination with a rack disposed directly below the respective sheet are configured to define a holding volume, wherein the holding volume is sized to closely receive a conventional restaurant pan therebetween.

4. The cabinet of claim 3, wherein each of the sheets are configured to contact a plurality of top edges of the pan disposed thereunder and substantially enclose an inner volume of the pan.

5. The cabinet of claim 4, wherein the pan is removable from the holding volume when in contact with the sheet directly above the pan.

6. The cabinet of claim 4, wherein the sheet is removable from the holding volume when in contact with the pan disposed directly below the sheet.

7. The cabinet of claim 1, wherein the plurality of heaters each are controlled by an infinite switch.

8. The cabinet of claim 1, wherein the plurality of racks comprise a plurality of planar members that enclose the respective heater disposed in conjunction with the respective rack.

9. The cabinet of claim 7, wherein the plurality of heaters are organized into a plurality of pairs of heaters with a single infinite switch controlling a respective pair of heaters.

10. A cabinet configured to receive and support a plurality of trays therein, comprising:
a housing defining an enclosure with a top, a bottom, and right and left sides disposed between the top and bottom;
a plurality of shelves disposed within the enclosure and disposed between the right and left sides in a spaced relationship;
one or more heaters disposed in conjunction with each of the plurality of shelves;
a cover disposed directly below at least some of the plurality of shelves, and configured to be slidably connected with respect to the shelf for selective placement into the enclosure or removal from the shelf; and
a control system in electrical communication with the one or more heaters, configured to operate the one or more heaters in a predetermined manner.

11. The cabinet of claim 10, wherein the control system is configured to selectively operate the one or more heaters to maintain a specified steady state temperature within the enclosure.

12. The cabinet of claim 10, wherein the control system is configured to selectively operate the one or more heaters to provide a constant heat output from the one or more heaters.

13. A cabinet configured to receive and support a plurality of trays therein, comprising:
a housing defining an enclosure with a top, a bottom, and right and left sides disposed between the top and bottom with substantially open front and back sides of the enclosure;
a plurality of shelves disposed within the enclosure and disposed between the right and left sides in a spaced relationship;
one or more heaters disposed in conjunction with each of the plurality of shelves;
a cover disposed directly below at least some of the plurality of shelves, and configured to be slidably connected the housing for selective placement into the enclosure or removal from the shelf; and
a control system in electrical communication with the one or more heaters, configured to operate the one or more heaters in a predetermined manner.

14. The cabinet of claim 13, wherein the cover is slidably connected to the respective shelf.
